(19) United States
(12) Patent Application Publication
(10) Pub. No.: US 2016/0130868 A1
(43) Pub. Date: May 12, 2016

(54) STABLE DEVICE FOR CURTAIN

(71) Applicant: CHING FENG HOME FASHIONS CO., LTD., Fuxing Shiang (TW)

(72) Inventors: SHENG YING HSU, Fuxing Shiang (TW); WU CHUNG NIEN, Fuxing Shiang (TW); CHUN JAN HSU, Fuxing Shiang (TW)

(21) Appl. No.: 14/922,185

(22) Filed: Oct. 25, 2015

(30) Foreign Application Priority Data
Nov. 7, 2014 (TW) 103219774

(51) Int. Cl. E06B 9/38; E06B 9/262

(52) U.S. Cl. CPC E06B 9/38; E06B 9/262; E06B 2009/2627

(57) ABSTRACT

A curtain assembly includes a top rail and a bottom rail, and a curtain is connected between the top and bottom rails. At least one wire extends through the top rail, the curtain and the bottom rail so as to collect and expand the curtain. A resilient member is horizontally connected to the top rail. The at least one wire extends through the resilient member. The two ends of the restriction member are respectively connected to the two ends of the resilient member so as to restrict the expanding distance of the resilient member. The stored force of the resilient member holds the curtain which is maintain stable and does not swing.

### BACKGROUND OF THE INVENTION

1. Fields of the Invention

The present invention relates to a curtain, and more particularly, to a stable device for avoiding the curtain from swing back and forth.

2. Descriptions of Related Art

The conventional curtains are installed at the inside of a room house so as to control the outside light from entering the room. There are many different types of curtains developed such as a honeycomb curtain which provides aesthetic features to the interior design of a room. The conventional honeycomb curtain generally comprises a top rail, a curtain and a bottom rail, wherein the curtain includes honeycomb-shaped cross section which provide better heat isolation so as to save thermal energy. However, because the honeycomb curtain is light in weight and usually made by soft material, so that it easily swings back and forth to hit the window frame and generates noise.

The present invention intends to provide a honeycomb curtain which has a stable device to eliminate the shortcomings mentioned above.

### SUMMARY OF THE INVENTION

The present invention relates to a curtain assembly and comprises a top rail, a bottom rail and a curtain, wherein the curtain is connected between the top and bottom rails. At least one wire extends through the top rail, the curtain and the bottom rail so as to collect and expand the curtain. A resilient member is horizontally connected to the top rail and has a first connection end and a second connection end. The at least one wire has a first end and a second end. The at least one wire extends through the resilient member and is connected to the first and second connection ends of the resilient member. The at least one wire restricts the expanding distance of the resilient member. The first and second ends of the at least one wire respectively extend through the curtain and are connected to the bottom rail.

Preferably, the resilient member is a spring, and the at least one wire extends axially through a center of the resilient member.

Alternatively, the present invention provides another curtain assembly which comprises a top rail, a bottom rail and a curtain. The curtain is connected between the top and bottom rails. A first wire and a second wire extend through the top rail and the curtain, and are securely connected to the bottom rail so as to collect and expand the curtain.

A resilient member and a restriction member are connected to the top rail, wherein the resilient member is horizontally connected to the top rail and has a first connection end and a second connection end. The first wire and the first end of the restriction member are connected to the first connection end of the resilient member, and the second wire and the second end of the restriction member are connected to the second connection end of the resilient member. The first and second wires restrict the expanding distance of the resilient member.

Preferably, the restriction member is a rope having a fixed length.

The primary object of the present invention is to provide a stable device of a curtain, wherein the wires controls the expanding distance of the resilient member so that when the curtain is expanded to a desired position, the stored energy in the resilient member properly keep tension to the curtain so that the curtain is maintained straight and does not swing easily.

Another object of the present invention is to provide a stable device of a curtain, wherein two ends of a restriction member are respectively connected to the two connection ends of the resilient member. The wires are also respectively connected to the two connection ends of the resilient member so as to control the expanding distance of the resilient member. When the curtain is expanded to a desired position, the stored energy in the resilient member properly keep tension to the curtain so that the curtain is maintained straight and does not swing easily.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the curtain assembly of the present invention, wherein the curtain is in collected status;

FIG. 2 is a front cross sectional view to show the curtain assembly of the present invention;

FIG. 3 is a perspective view to show the curtain assembly of the present invention, wherein the curtain is in expanded status;

FIG. 4 is a front cross sectional view to show the curtain assembly of the present invention, wherein the curtain is in expanded status, and

FIG. 5 is a perspective view to show the second embodiment of the curtain assembly of the present invention, wherein the curtain is in collected status.

### DETAILED DESCRIPTION OF THE PREFERRED EMBODIMENT

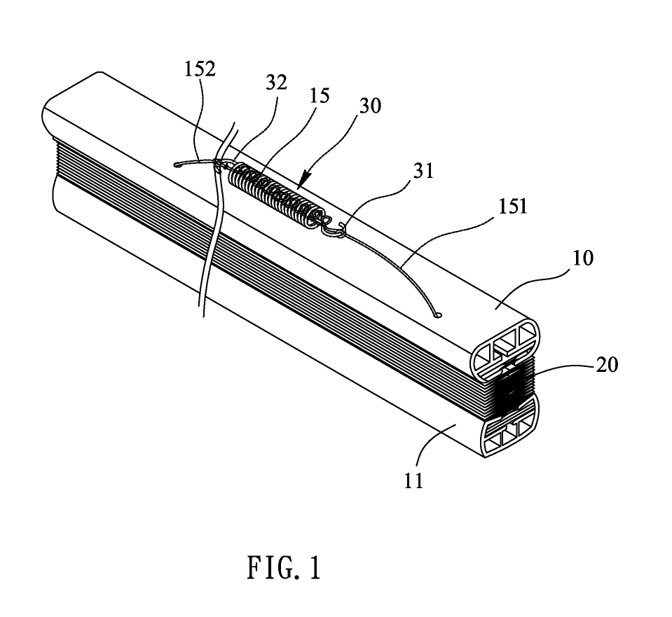

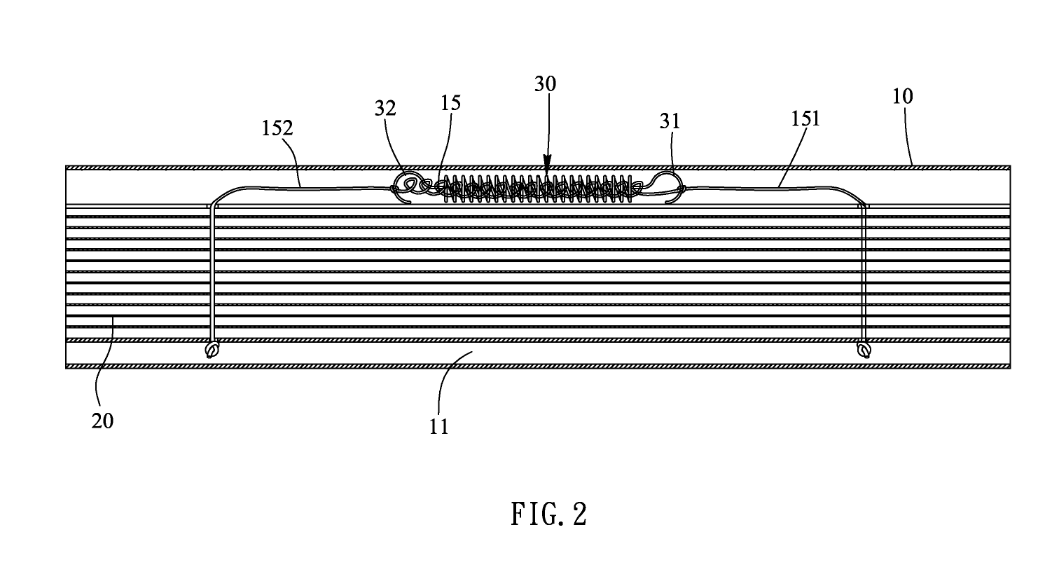

Referring to FIGS. 1 and 2, the curtain assembly of the present invention comprises a top rail 10, a bottom rail 11 and a curtain 20. The curtain 20 is connected between the top and bottom rails 10, 11. A wire 15 extends through the top rail 10, the curtain 20 and the bottom rail 11 so as to collect and expand the curtain 20.

The stable device of the present invention has a resilient member 30 which is horizontally connected to the top rail 10 and has a first connection end 31 and a second connection end 32. The resilient member 30 can be a spring or a resilient rope. The at least one wire 15 has a first end 151 and a second end 152. The wire 15 extends axially through the center of the resilient member 30, and is connected to the first and second connection ends 31, 32 of the resilient member 30. The purpose that the wire 15 is connected to the first and second connection ends 31, 32 of the resilient member 30 is to restrict the expanding distance of the resilient member 30. The first and second ends 151, 152 of the wire 15 respectively extend through the curtain 20 and are connected to the bottom rail 11. When the curtain 20 is in the collected status, the resilient member 30 is not expanded, and a portion of the wire 15 is received within the resilient member 30 as shown in FIGS. 1 and 2.

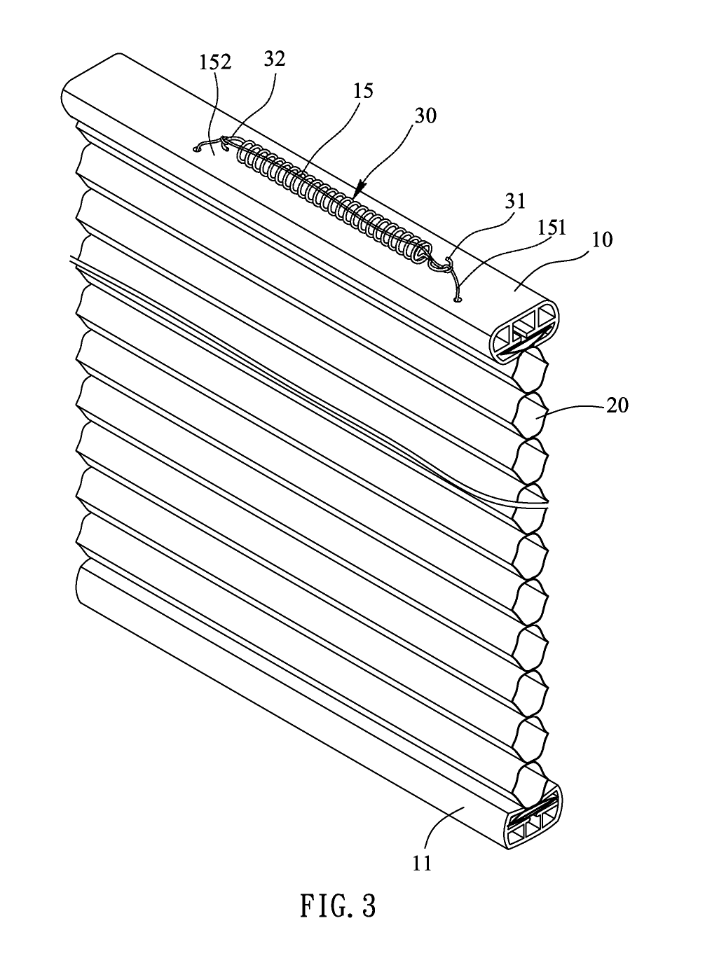

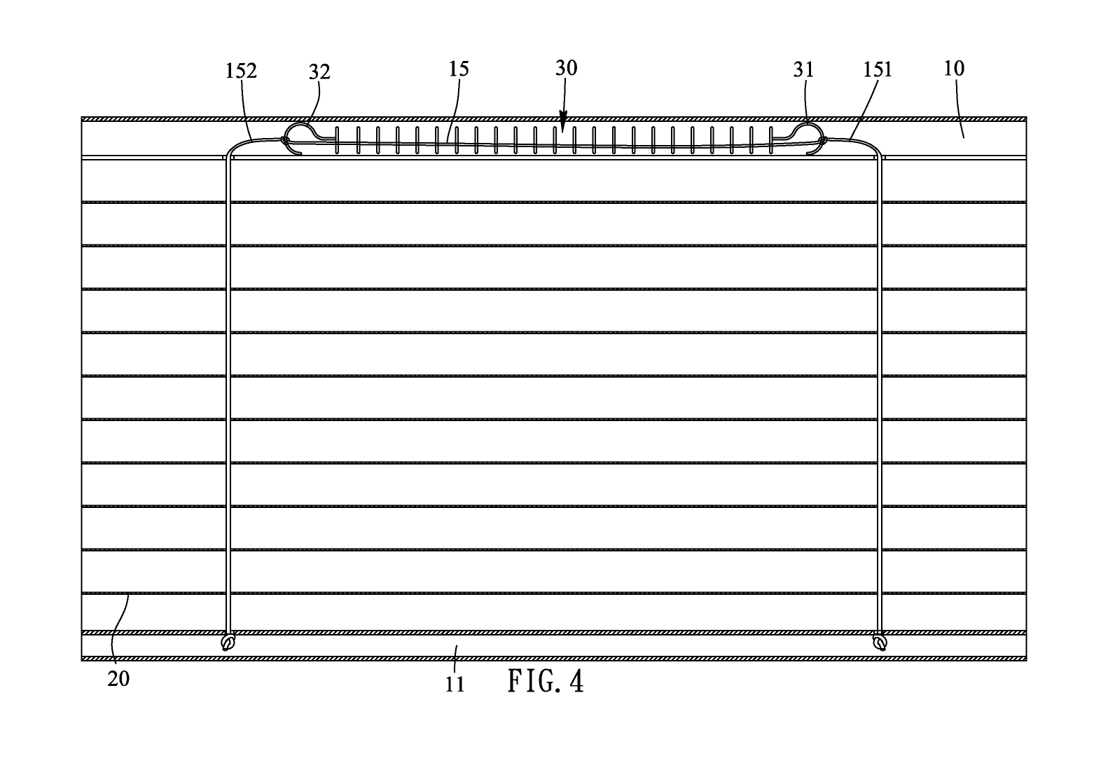

As shown in FIGS. 3 and 4, when the curtain 20 is expanded, the first and second ends of the wire 15 extend the resilient member 30 until the first and second ends 151, 152 of the wire 15 are fully extended, the curtain 20 is fully expanded. The wire 15 is horizontally extended and the resilient member 30 is restricted by the wire 15 and cannot be further expanded. The stored energy in the resilient member 30 properly keeps tension to the curtain 20 so that the curtain 20 is maintained straight and does not swing easily.

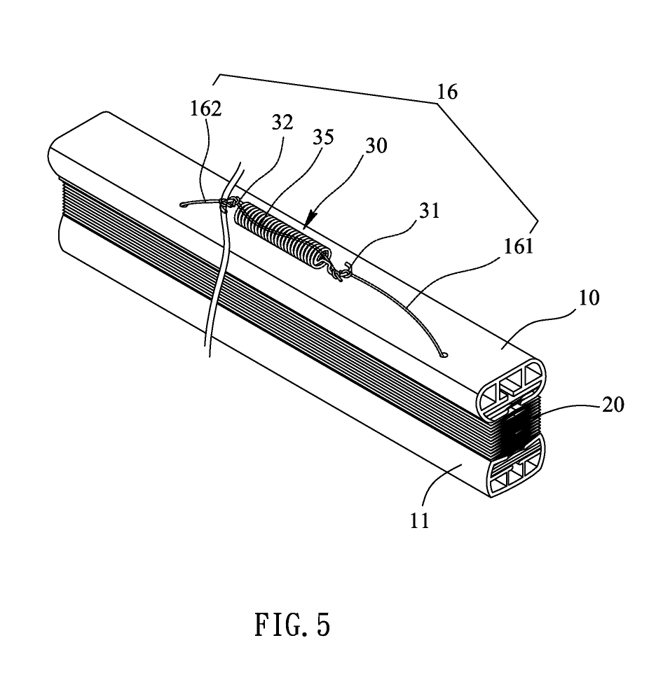

As shown in FIG. 5, the second embodiment of the present invention provides a restriction member 35 to be cooperated with the resilient member 30. The curtain assembly comprises a top rail 10, a bottom rail 11 and a curtain 20. The curtain 20 is connected between the top and bottom rails 10, 11. A first wire 161 and a second wire 162 extend through the top rail 10 and the curtain 20, and are securely connected to the bottom rail 11 so as to collect and expand the curtain 20.

A resilient member 30 and a restriction member 35 are connected to the top rail 10, wherein the resilient member 30 is horizontally connected to the top rail 10 and has a first connection end 31 and a second connection end 32. The first wire 161 and the first end of the restriction member 35 are connected to the first connection end 31 of the resilient member 30, and the second wire 162 and the second end of the restriction member 35 are connected to the second connection end 31 of the resilient member 30. The first and second wires 161, 162 restrict the expanding distance of the resilient member 30. The restriction member 35 is a rope having a fixed length.

Similarly, when the curtain 20 is fully expanded, the restriction member 35 is straightened and the resilient member 30 is restricted by the wire 15 and cannot be further expanded. The stored energy in the resilient member 30 properly keeps tension to the curtain 20 so that the curtain 20 is maintained straight and does not swing easily.

While we have shown and described the embodiment in accordance with the present invention, it should be clear to those skilled in the art that further embodiments may be made without departing from the scope of the present invention.

What is claimed is:

1. A curtain assembly comprising:
a top rail, a bottom rail and a curtain, the curtain connected between the top and bottom rails, at least one wire extending through the top rail, the curtain and the bottom rail so as to collect and expand the curtain, and
a resilient member horizontally connected to the top rail and having a first connection end and a second connection end, the at least one wire having a first end and a second end, the at least one wire extending through the resilient member and connected to the first and second connection ends of the resilient member, the at least one wire restricting an expanding distance of the resilient member, the first and second ends, of the at least one wire respectively extending through the curtain and connected to the bottom rail.

2. The curtain assembly as claimed in claim 1, wherein the resilient member is a spring, the at least one wire extends axially through a center of the resilient member.

3. A curtain assembly comprising:
a top rail, a bottom rail and a curtain, the curtain connected between the top and bottom rails, a first wire and a second wire extending through the top rail and the curtain, and securely connected to the bottom rail so as to collect and expand the curtain, and
a resilient member and a restriction member connected to the top rail, the resilient member horizontally connected to the top rail and having a first connection end and a second connection end, the first wire and a first end of the restriction member connected to the first connection end of the resilient member, the second wire and a second end of the restriction member connected to the second connection end of the resilient member, the first and second wires restricting an expanding distance of the resilient member.

4. The curtain assembly as claimed in claim 3, wherein the restriction member is a rope having a fixed length.
